(19) United States
(12) Patent Application Publication
(10) Pub. No.: US 2005/0276482 A1
(43) Pub. Date: Dec. 15, 2005

(54) [PORTABLE ELECTRIC APPARATUS WITH CHARACTER RECOGNITION FUNCTION]

(76) Inventors: Chengshing Lai, Taipei (TW); Renping Cao, Nanking (CN)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/709,737

(22) Filed: May 26, 2004

(51) Int. Cl. G06K 9/46

(52) U.S. Cl. 382/202

(57) ABSTRACT

A portable electronic apparatus having character recognition, including a body, an image input unit, an image output unit and an instruction input unit. First, the body has a major circuitry and a character recognition circuit, wherein the character recognition circuit, coupled to the host circuit, serves to transform a digital image to a digital text document. Moreover, the image input unit, the image output unit and the instruction input unit are electrically coupled to the host circuit.

### BACKGROUND OF INVENTION

1. Field of Invention

The present invention relates to a portable electronic apparatus, and more particularly, to a portable electronic apparatus that is capable of recognizing characters.

2. Description of the Related Art

In this information age, human life is tightly tied to electronic communication. Sending messages between electronic communication apparatuses is more and more popular, especially via those portable electronic apparatus, e.g. mobile telephones or electronic apparatuses that serve for wireless communication.

Advanced mobile communication technology being in demand nowadays, mobile communication apparatuses are therefore more developed. In addition to radio functionality, camera functionality is generally equipped with a mobile communication apparatus as well. For example, when taking picture is needed, a handy mobile communication apparatus serves to capture digital image and transmit which to other remote users via wireless communication service system. Similarly, when an article or report deserves to be saved, it can be done with a mobile communication apparatus equipped with camera functionality. It is noted that since the digital image captured by the mobile communication apparatus is not a digital text document, the digital image has to be uploaded to a computer for transforming from a digital image into a digital text document before being edited.

However, although the conventional mobile communication apparatus is equipped with camera facility, a digital image containing text content can not be directly transformed into a digital text embodimentembodimentdocument thereby. Therefore, a digital image can not be promptly transformed into a digital text document for further editing before uploading to a computer.

### SUMMARY OF INVENTION

In light of the above, the present invention provides a portable electronic apparatus having character recognition function and method for capturing a digital image containing text content and for transforming into a digital text document via the portable electronic apparatus.

The present invention provides a portable electronic apparatus having character recognition function, including a host body, an image input unit, an image output unit, and an instruction input unit. The host body includes a host circuit and a character recognition circuit, wherein the character recognition circuit is electrically coupled to the host circuit, for transforming a digital image into a digital text document. Moreover, the image input unit, the image output unit and the instruction input unit are all electrically coupled to the host circuit.

The present invention also provides a character recognition method adapted to a portable electronic apparatus. First, an analog image is captured via the portable electronic apparatus and is transformed into a digital image by the portable electronic apparatus. The digital image is recognized as a digital text document via the portable apparatus thereafter.

According to one embodiment of the present invention, the step of recognizing the digital image as the digital text document further includes analyzing the digital image to a plurality of digital image areas according to character distribution of the digital image, and recognizing the digital image areas as a plurality of digital characters for further assembling into the foregoing digital text document.

According to the embodiment of the present invention, the step of recognizing the digital image areas into a plurality of digital characters further includes dividing each of the digital image area to a characteristic stroke and then to one of the digital characters thereafter.

According to the embodiment of the present invention, the step of recognizing the digital image areas to digital characters further includes correcting the digital characters.

In light of the above, the present invention provides a built-in character recognition circuit for a portable electronic apparatus having camera function. Therefore, an analog image is captured directly via the image input unit of the portable electronic apparatus, and transformed into a digital image then a digital text document afterwards. The digital text document thus can be read and edited thereby.

### BRIEF DESCRIPTION OF DRAWINGS

FIG. 1 is a schematic block diagram illustrating a portable electronic apparatus having character recognition function according to an embodiment of the present invention.

FIG. 2 is a schematic flow chart illustrating a method of character recognition according to an embodiment of the present invention.

### DETAILED DESCRIPTION

The present invention provides a portable electronic apparatus having character recognizing function and method for capturing an analog image, and transforming the analog image to a digital image, then recognizing the digital image as a digital text document thereafter.

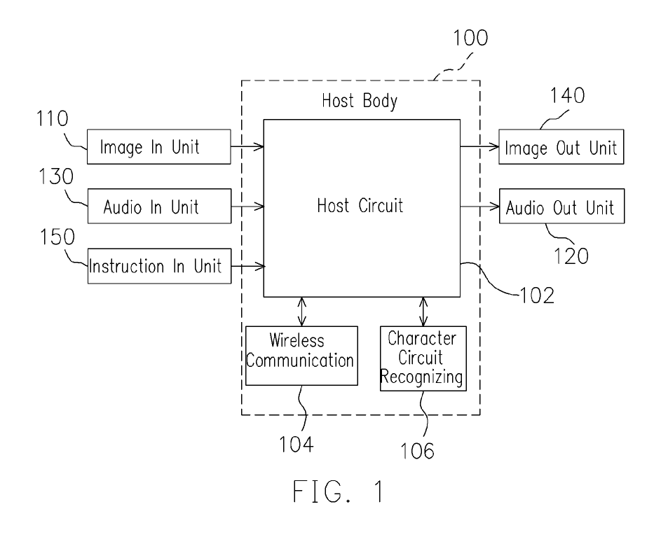

Referring to FIG. 1, a schematic block diagram of a portable electronic apparatus having character recognition function according to one embodiment of the present invention is illustrated. The portable electronic apparatus in the present invention includes a host body 100, an image input unit 110, an image output unit 140 and an instruction input unit 150. In this embodiment, the portable electronic apparatus is a mobile telephone or an electronic apparatus with wireless communication, for example. The portable electronic apparatus further includes an audio output unit 120 and an audio input unit 130, both electrically coupled to a host circuit 102. Furthermore, the host body 100 includes a wireless communication circuit electrically coupled to the host circuit 102. The image input unit is exemplary a video camera lens, the audio output unit 120 is exemplary a speaker, the audio input unit 130 is exemplary a microphone, the image output unit 140 is exemplary a flat panel display, and the instruction input unit 150 is exemplary a keyboard. Moreover, the image output unit 140 and the instruction input unit 150 can be embodied with a touch screen display.

Referring to FIG. 1, the host body 100 includes a host circuit 102 and a character recognition circuit 106, wherein the character recognition circuit 106 is electrically coupled to the host circuit 102. Furthermore, the image input unit 110, the image output unit 140 and the instruction input unit 150 are coupled to the host circuit 102. In the embodiment, the portable electronic apparatus is operated via the instruction input unit 150 and the image output unit 140. Similarly, in the embodiment an analog image is captured via the image input unit 110, transformed into a digital image thereby, and transformed to a digital text document via the character recognition circuit 106. It is noted that the host circuit 102 further includes a wireless communication circuit, a data storage circuit and a power supply circuit, or other circuits needed besides the character recognition circuit 106.

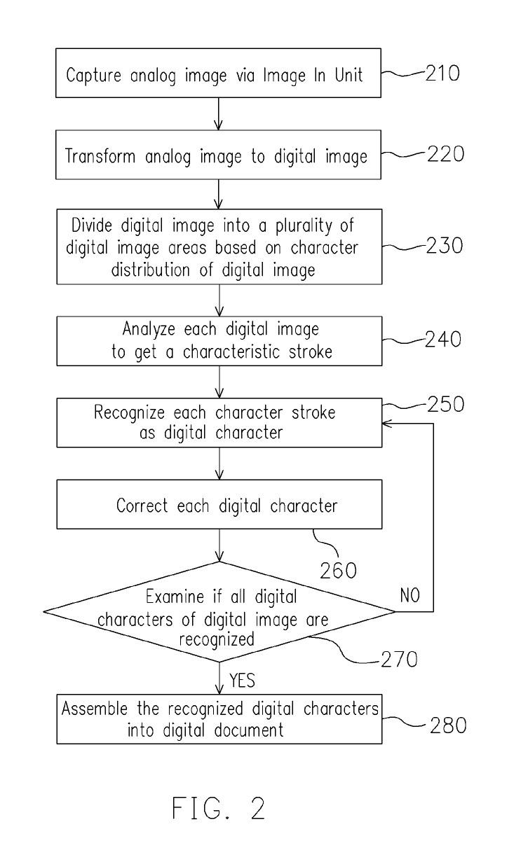

Referring to FIGS. 1 and 2, wherein FIG. 2 illustrates a flow chart of a method of character recognition according to one embodiment of the present invention. The character recognition method in the embodiment applies to a portable electronic apparatus, which is exemplary a mobile telephone, or an electronic apparatus with wireless communication function. First considering step 210, an analog image is captured via an image input unit 110 of the mobile communicating apparatus. Then considering step 220, the captured analog image is transformed into a digital image. In step 230, the digital image is divided into a plurality of digital image areas according character distribution of the digital image. Then, in step 240, each of the digital image blocks is divided into at least a characteristic stroke. In step 250, each the characteristic stroke is recognized as a digital character. In step 260, each the digital character is corrected in a given order. In step 270, whether all the characteristic strokes of the digital image are recognized is determined. If not, return to the step 250, and recognizing the remaining characteristic strokes to digital characters is continued. If character recognition is completed, the method of character recognition is proceeded to step 280 for assembling the recognized digital characters into a digital text document based on corresponding stroke distribution of the digital image.

In light of the above description, the portable electronic apparatus having character recognition function captures an analog image via an image input unit thereof, and transforming the analog image into a digital image and to a digital text document consequently. Therefore, a digital image containing text content is captured directly via the portable electronic apparatus and transformed into a digital text document. Moreover, the digital text document can be read or edited on the portable electronic apparatus, and transmitted to remote users when the portable electronic apparatus being a mobile telephone or other apparatus with wireless communication function operated by wireless communication service system, or even transmitted to a computer via transmission peripherals. The invention enhances the portable electronic apparatus as a result.

Although the invention has been described with reference to a particular embodiment thereof, it will be apparent to those skilled in the art that modifications to the described embodiment may be made without departing from the spirit of the invention. Accordingly, the scope of the invention will be defined by the attached claims and not by the above detailed description.

1. A portable electronic apparatus having a character recognition function, comprising:
a host body, having a host circuit and a character recognition circuit, wherein the character recognition circuit is electrically coupled to the host circuit, and the character recognition circuit serves to transform a digital image to a digital text document;
an image input unit, coupled to the host circuit;
an image output unit, coupled to the host circuit; and
an instruction input unit, coupled to the host circuit.

2. The apparatus as recited in claim 1, wherein the image output unit and the instruction input unit comprise a touch screen display.

3. The apparatus are recited in claim 1, wherein the host body further comprises a wireless communication circuit coupled to the host circuit.

4. The apparatus as recited in claim 3 further comprising an audio output and an audio input output unit, coupled to the host circuit.

5. A character recognition method, for a portable electronic apparatus, wherein the portable electronic apparatus has an image input unit, the method comprising:
capturing an analog image from the image input unit;
transforming the analog image into a digital image; and
recognizing the digital image as a digital text document.

6. The method as recited in claim 5, wherein the step of recognizing the digital image as a digital text document comprising:
dividing the digital image into a plurality of digital image areas according to a character distribution of the digital image; and
recognizing the digital image area as a plurality of digital characters, and assembling the digital characters into the digital text document.

7. The method as recited in claim 6, wherein the step of recognizing the digital image areas as the digital characters comprising:
dividing each of the digital image areas into at least a characteristic stroke; and
recognizing each the characteristic stroke as one of the digital characters.

8. The method as recited in claim 7, wherein the step of recognizing as the digital image characters comprising correcting the digital characters.
